(19) United States
(12) Patent Application Publication
(10) Pub. No.: US 2014/0363366 A1
(43) Pub. Date: Dec. 11, 2014

(54) PROCESS FOR MAKING TITANIUM COMPOUNDS

(71) Applicant: E I DU PONT DE NEMOURS AND COMPANY, Wilmington, DE (US)

(72) Inventor: JEFFERY SCOTT THOMPSON, West Chester, PA (US)

(21) Appl. No.: 13/910,221

(22) Filed: Jun. 5, 2013

(51) Int. Cl. C01D 15/02

(52) U.S. Cl. CPC C01D 15/02
USPC 423/598

(57) ABSTRACT

A process for the preparation of Li₄Ti₅O₁₂ by a novel, low-cost route from titanium tetrachloride is described. In the process disclosed herein, conditions have been discovered which result in the preparation of Li₄Ti₅O₁₂ having a high purity and a high surface area. These properties are useful for good performance in a lithium ion battery.

### TECHNICAL FIELD

The subject matter of this disclosure relates to a process for the preparation of Li₄Ti₅O₂₂ by a novel, low-cost route from titanium tetrachloride.

### BACKGROUND

Lithium ion batteries (LIBs) have many current and potential uses, including grid-scale energy storage and transportation (e.g. hybrid electric vehicles, electric vehicles and electric trains).

There has been a number of battery systems developed for energy storage needs. LIBs are well-suited for this purpose in terms of performance (round-trip efficiency, life time, and ease of use) when compared with other alternatives such as molten salt batteries and advanced lead-acid batteries. The major factors in technology choice for grid-scale energy storage are cost, lifetime, and safety. Lithium titanate (LTO) anodes, specifically, Li₄Ti₅O₁₂, have been shown to offer several advantages for use in lithium ion batteries, including a long life time and safe operation owing to the materials of construction and the absence of electrochemical decomposition of the electrolyte at the electrode surface.

Methods for preparing LTO are known in the art. For example, a widely used method to prepare LTO is the solid-state reaction of TiO₂ with lithium carbonate.

Another method known in the art is based on the use of TiCl₄ in an HCl solution containing LiCl. The solution is spray dried to yield a solid that contains rutile and a Li salt; there is no reaction between the two materials in the mixture at this point. The mixture is calcined at about 800-1000° C. to generate LTO. The LTO then goes through repeated grinding and additional calcining steps to achieve nano-sized particles.

Similar methods have been described to prepare LTO that involve addition of TiCl₄ to an aqueous solution followed by neutralization of by-product HCl with ammonia. Titanium dioxide as anatase is generated in this step. This titanium dioxide is mixed with LiOH and is then spray dried to yield particles of desired sized. Calcination under nitrogen and then under ambient atmosphere yields LTO.

Additionally, Thompson (WO 2011/146838 A2) describes a process for preparing LTO which comprises hydrolyzing TiCl₄ to provide titanium oxychloride, which is then hydrolyzed to yield titanium dioxide. The titanium dioxide is mixed with a lithium salt to give LTO.

Methods to prepare high purity titanium dioxide having controlled particle size, which can be used to prepare LTO, are also known in the art (e.g., Lawhorne, U.S. Pat. No. 4,944,936) and Roberts et al., U.S. Pat. No. 4,923,682)

Because the cost for materials is the largest cost component in LIB manufacture, the use of low-cost materials will offer a significant commercial advantage. A need thus remains for a simple, streamlined preparation of LTO having useful properties (such as high purity and a high surface area) for LIB applications by a process that uses inexpensive reagents.

### SUMMARY

In one embodiment, there is provided herein a process for preparing Li₄Ti₅O₁₂, comprising the steps of:
a) hydrolyzing TiCl₄ in an aqueous medium to provide a first aqueous solution containing TiOCl₂ at a concentration of about 0.5 M to about 2.0 M;
b) generating a seed suspension by adding a portion of the first aqueous solution containing TiOCl₂ to a second aqueous medium to provide a second aqueous solution containing TiOCl₂ at a concentration of about 0.01 M to about 0.1 M, and agitating and heating the second aqueous solution to a temperature of about 60° C. to about 80° C. for a period of time sufficient to provide the seed suspension containing hydrated titanium dioxide particles having a particle size less than 100 nm;
c) generating a suspension containing hydrated TiO₂ particles by adjusting the temperature of the seed suspension to about 70° C. to about 100° C., adding the first aqueous solution containing TiOCl₂ to the seed suspension at a rate of less than 15 mL/L/min while agitating the seed suspension to provide a reaction mixture having a concentration of TiOCl₂ of about 0.7 M to about 1.8 M, and continuing agitating and heating the reaction mixture at a temperature of about 70° C. to about 100° C. for a period of time sufficient to prepare the suspension containing hydrated TiO₂ particles, wherein the hydrated TiO₂ particles have a particle size of about 0.4 μm to about 5.0 μm;
d) recovering the hydrated TiO₂ particles from the suspension of step (c);
e) mixing the hydrated TiO₂ particles with a lithium salt to prepare a mixture having a Li to Ti ratio of about 0.6 to about 1.0; and
f) calcining the mixture from step (e) at a temperature of about 750° C. to about 1,000° C. for a period of time sufficient to prepare Li₄Ti₅O₁₂.

In another embodiment, there is provided herein a process for preparing titanium dioxide, comprising the steps of:
a) hydrolyzing TiCl₄ in an aqueous medium to provide a first aqueous solution containing TiOCl₂ at a concentration of about 0.5 M to about 2.0 M;
b) generating a seed suspension by adding a portion of the first aqueous solution containing TiOCl₂ to a second aqueous medium to provide a second aqueous solution containing TiOCl₂ at a concentration of about 0.01 M to about 0.1 M, and agitating and heating the second aqueous solution to a temperature of about 60° C. to about 80° C. for a period of time sufficient to provide the seed suspension containing hydrated titanium dioxide particles having a particle size less than 100 nm;
c) generating a suspension containing hydrated TiO₂ particles by adjusting the temperature of the seed suspension to about 70° C. to about 100° C., adding the first aqueous solution containing TiOCl₂ to the seed suspension at a rate of less than 15 mL/L/min while agitating the seed suspension to provide a reaction mixture having a concentration of TiOCl₂ of about 0.7 M to about 1.8 M, and continuing agitating and heating the reaction mixture at a temperature of about 70° C. to about 100° C. for a period of time sufficient to prepare the suspension containing hydrated TiO₂ particles, wherein the hydrated TiO₂ particles have a particle size of about 0.4 μm to about 5.0 μm;
d) recovering the hydrated TiO₂ particles from the suspension of step (c).

### DETAILED DESCRIPTION

Disclosed herein is a process for preparing Li₄Ti₅O₁₂. The process comprises several steps. The first step is the hydrolysis of titanium tetrachloride (TiCl₄) to yield an aqueous solution containing titanium oxychloride (TiOCl₂). The second step, involves the thermal hydrolysis of TiOCl₂ to provide hydrated titanium dioxide, typically in the rutile phase. The first two steps of the process are shown in Equation 1.

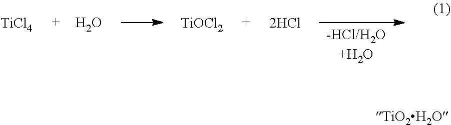

The hydrated titanium dioxide formed is mixed with a lithium salt and the resulting mixture is calcined to yield the Li₄Ti₅O₁₂. For example, the hydrated titanium dioxide can be mixed with Li₂CO₃ and calcined at 800° C., as shown in Equation 2.

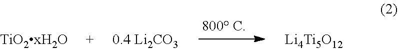

In the process disclosed herein, conditions have been discovered which result in the preparation of Li₄Ti₅O₁₂ having a high purity and a high surface area. These properties are critical for good performance of the Li₄Ti₅O₁₂ as an anode active material in a lithium ion battery. The intermediate titanium dioxide formed in the process also has the advantageous properties recited above and can also be used for other applications.

More specifically, in the first step of the process disclosed herein, TiCl₄ is added to a first aqueous medium with agitation, typically at a rate in the range of about 40 mL/hour to about 60 mL/hour, or a range of about 45 mL/hour to about 55 mL/hour. In one embodiment, the aqueous medium is water which does not contain additional components or reagents, such as a surfactant or an acid such as HCl. The TiCl₄ is preferably handled under an inert, dry atmosphere until addition is performed. The aqueous medium can be maintained at a temperature in the range of about −20° C. to about 20° C., or about −5° C. to about 5° C., or at a temperature of about 0° C. This step provides a first aqueous solution containing TiOCl₂ at a concentration of about 0.5 M to about 2.0 M, or about 1.0 M to about 2.0 M or about 1.5 M to about 2.0 M, or about 1.8 M to about 2.0 M. The TiOCl₂ can be isolated by any conventional means, or can also be, and is more typically, used as the first aqueous solution in further steps of the process.

In the next step in the process disclosed herein, a seed suspension is generated by adding a portion of the first aqueous solution containing TiOCl₂ to a second aqueous medium to provide a second aqueous solution containing TiOCl₂ at a concentration of about 0.01 M to about 0.10 M, or about 0.02 M to about 0.10 M, or about 0.02 M to about 0.05 M. In one embodiment, the second aqueous medium is water which does not contain additional components or reagents, such as a surfactant or an acid such as HCl. The second aqueous solution is agitated and heated to a temperature of about 60° C. to about 80° C., or about 65° C. to about 80° C., or about 65° C. to about 75° C., or about 65° C. to about 70° C. for a period of time sufficient to provide the seed suspension containing hydrated titanium dioxide particles having a particle size less than 100 nm. Agitation can be by any means and is typically at a rate of about 400 rpm to about 1200 rpm, or about 500 rpm to about 1200 rpm, or about 1,000 rpm to about 1200 rpm. Typically, the second aqueous solution is agitated and heated for about 60 min to about 120 min, or about 90 min.

In the next step, a suspension containing hydrated TiO₂ particles is generated by adjusting the temperature of the seed suspension to about 70° C. to about 100° C., or about 75° C. to about 90° C., or about 75° C. to about 85° C. or about 75° C., and adding the first aqueous solution containing TiOCl₂ to the seed suspension at a rate of less than 15 mL/L/min, or about 1.0 mL/L/min to about 10.0 mL/L/min, or about 2.5 mL/L/min to about 5.5 mL/L/Min, or about 4.0 mL/L/min to about 5.5 mL/L/min, to provide a reaction mixture having a concentration of TiOCl₂ of about 0.7 M to about 1.8 M. During this addition, the seed suspension is agitated at a rate of about 0.15 m/s to about 15 m/s, or about 1 m/s to about 10 m/s, or about 2 m/s to about 8 m/s. In one embodiment, the seed suspension is agitated at a rate to give turbulent flow, resulting in a Reynolds number higher than 10000. As known in the art of fluid mechanics, the Reynolds number is a dimensionless number defined as the ratio of dynamic pressure and shearing stress. The resulting reaction mixture is agitated and heated at a temperature of about 70° C. to about 100° C. for a period of time sufficient to prepare the suspension containing hydrated TiO₂ particles having a particle size of about 0.4 μm to about 5.0 μm. Typically, the reaction mixture is heated and agitated for a time of about 10 min to about 360 min, or about 15 min to about 240 min, or about 20 min to about 140 min, or about 120 to about 135 min.

The TiO₂ formed is typically in rutile phase, or is a mixture of substantially rutile phase with other phases. The TiO₂ can be recovered, typically as a dried solid, using conventional methods such as filtration, centrifugation, decantation, settling, or any combination thereof. Typically the TiO₂ is isolated in a hydrated form. The titanium dioxide referred to herein can thus be crystalline or amorphous TiO₂, or hydrated crystalline or hydrated amorphous TiO₂, or a mixture thereof. The recovered TiO₂ particles can be washed with water to remove the HCl formed in the hydrolysis reaction.

Processes to prepare titanium dioxide can be performed by using the steps as set forth above.

Next, the hydrated TiO₂ particles are mixed with a lithium salt to prepare a mixture having a Li to Ti ratio of about 0.6 to about 1.0, or about 0.7 to about 0.9, or about 0.78 to about 0.82. Suitable lithium salts include without limitation, lithium hydroxide, lithium carbonate, lithium sulfate, lithium phosphate, lithium nitrate, and lithium carboxylates such as lithium formate, lithium acetate, lithium citrate, lithium benzoate, or mixtures thereof. In one embodiment, the lithium salt is lithium carbonate.

Then, the mixture of the hydrated TiO₂ particles and the lithium salt is calcined by heating to a temperature of about 750° C. to about 1,000° C., or about 750° C. to about 900° C., or about 750° C. to about 900° C., or about 800° C. for a time sufficient to prepare Li₄Ti₅O₁₂. Calcining can be conducted for a time period of at least about 0.5 hours, at least about 1 hour, or at least about 2 hours, and yet no more than about 20 hours, or no more than about 10 hours, or no more than about 6 hours; or a time period in the range of about 0.5 to about 20 hours. Heating can be conducted with conventional equipment such as an oven.

The process disclosed herein yields LTO particles having a purity greater than 92% and a surface area greater than or equal to 2.0 m²/g, or about 2.0 m²/g to about 10 m²/g, or about 2.0 m²/g to about 4.0 m²/g. The purity can be determined using X-ray diffraction analysis (XRD). The surface area of the LTO particles can be determined by BET surface analysis.

The LTO produced by the process disclosed herein can be used to fabricate electrodes for use in an electrochemical cell such as a battery. An electrode is prepared by forming a paste from the LTO and a binder material such as a fluorinated (co)polymer (e.g. polyvinylfluoride) by dissolving or dispersing the solids in water or an organic solvent. The paste is coated onto a metal foil, preferably an aluminum or copper foil, which is used as a current collector. The paste is dried, preferably with heat, so that the solid mass is bonded to the metal foil.

The electrode described above can be used to fabricate an electrochemical cell such as a battery. In one embodiment, the battery is a lithium ion battery. An electrode, prepared as described above, is provided as the anode or cathode (usually the anode), and a second electrode is provided by similar preparation from electrically-active materials such as platinum, palladium, electroactive transition metal oxides comprising lithium, or a carbonaceous material including graphite as the other electrode. The two electrodes are layered in a stack but separated therein by a porous separator that serves to prevent short circuiting between the anode and the cathode. The porous separator typically consists of a single-ply or multi-ply sheet of a microporous polymer such as polyethylene, polypropylene, or a combination thereof. The pore size of the porous separator is sufficiently large to permit transport of ions, but small enough to prevent contact of the anode and cathode either directly or from particle penetration or dendrites which can form on the anode and cathode.

The stack can be rolled into an elongated tube form and is assembled in a container with numerous other such stacks that are wired together for current flow. The container is filled with an electrolyte solution, such as a linear or cyclic carbonate, including ethyl methyl carbonate, dimethyl carbonate or diethylcarbonate. The container when sealed forms an electrochemical cell such as a battery.

The electrochemical cell disclosed herein may be used for grid storage or as a power source in various electronically-powered or -assisted devices (“Electronic Device”) such as a transportation device (including a motor vehicle, automobile, truck, bus or airplane), a computer, a telecommunications device, a camera, a radio or a power tool.

### EXAMPLES

The operation and effects of certain embodiments of the inventions hereof may be more fully appreciated from a series of examples, as described below. The embodiments on which these examples are based are representative only, and the selection of those embodiments to illustrate the invention does not indicate that reactants, conditions, specifications, steps, techniques or protocols not described in the examples are not suitable for use herein, or that subject matter not described in the examples is excluded from the scope of the appended claims and equivalents thereof.

The meaning of abbreviations used in the following examples is as follows: “g” means gram(s), “mg” means milligram(s), “μg” means microgram(s), “L” means liter(s), “mL” means milliliter(s), “mol” means mole(s), “mmol” means millimole(s), “M” means molar concentration, “wt %” means percent by weight, “h” means hour(s), “min” means minute(s), “m” means meter(s), “cm” means centimeter(s), “mm” means millimeter(s), “μm” means micrometer(s), “nm” means nanometer(s), “rpm” means revolutions per minute, “A” means ampere(s), “mA” means milliampere(s), “mAh/g” means milliampere hour(s) per gram, “V” means volt(s), “xC” refers to a constant current which is the product of x and a current in A which is numerically equal to the nominal capacity of the battery expressed in Ah, “XRD” means X-ray diffraction, “TGA” means thermal gravimetric analysis, “SEM” means scanning electron microscopy.

### Materials

Chemicals were reagent grade or better and used as received. Ion-chromatography grade water from a Sartorius Arium 611DI unit (Sartorius North America Inc., Edgewood, N.Y.) was used to prepare solutions and rinse glassware. Titanium tetrachloride was purchased from Sigma-Aldrich (Milwaukee, Wis.; 208566-1.5KG in SureSeal™ bottle) and used without additional purification. Lithium carbonate was purchased from Alfa Aesar (Ward Hill, Mass.; Puratronic®>99.998%) and Sweco milled before use. Lithium nitrate was purchased from Sigma-Aldrich (227986-100G) and ball-milled at least 24 hours prior to use. Filtration of aqueous solutions to recover hydrated titanium dioxide was done using Whatman GF/F 90 mm filters (Whatman Inc., Clifton, N.J.; catalog number 1825-090).

### Example 1

### Preparation of Hydrated Titanium Dioxide

Hydrated titanium dioxide was prepared by a two-step process. First, titanium tetrachloride (TiCl₄) was hydrolyzed in an aqueous medium to provide titanium oxychloride (TiOCl₂), which was subsequently hydrolyzed to titanium dioxide (TiO₂).

Titanium tetrachloride (TiCl₄, 50 mL) was loaded into a 60-mL plastic syringe in a Vacuum Atmospheres dry box under a nitrogen atmosphere. The loaded syringe was removed from the dry box and placed on a syringe pump. The tetrachloride was added to vigorously stirred water (400 mL) cooled in an ice bath in a laboratory fume hood. The delivery rate was 1 mL/min. This procedure was repeated to generate a solution of approximately 1.8 M TiOCl₂. A clear, colorless solution was produced and was stored in a glass bottle at room temperature. The titanium concentration was determined by ICP-AES (inductively coupled plasma-atomic emission spectroscopy).

TiOCl₂ (3.3 mL of a 1.86 M solution prepared as described above) and water (240.8 mL) were added to a 1.0 L Morton Flask. The flask was mounted in a sand bath in a 2 L heating mantle. The temperature of the solution was controlled with a thermocouple inserted into the liquid. Stirring was done with an overhead stirrer with a single paddle impeller set at 1,100 rpm. The solution was held at 65° C. for approximately 90 min to allow time for the creation of seed crystals. After 90 min, the TiOCl₂ solution (1.86 M solution prepared as described above) was added at a rate of 4.2 mL/L/min using an addition funnel to bring the titanium concentration to 1 M in the flask; at the start of this addition, the flask temperature was raised to 75° C. The addition took approximately 2 h to complete, and then the resulting mixture was stirred at temperature for an additional 30 min. The reaction mixture was then filtered, and the collected solids were washed with water and air-dried overnight.

Hydrated titanium dioxide (57.0907 g) was recovered after drying. The titanium content of this solid was 37.80% as determined by ICP-AES. BET surface area analysis gave a surface area of 135 m²/g. The XRD pattern shows rutile with 20% anatase, and the SEM images show small clusters of tiny spherical particles.

### Example 2

### Preparation of Li₄Ti₅O₁₂ from Hydrated Titanium Dioxide

The hydrated titanium dioxide described in Example 1 (5.2838 g) was placed in a 2 ounce (29.6 mL) poly(tetrafluoroethylene)(PTFE)-lined square glass jar and dried for 4 h in a vacuum oven at 75° C. Lithium nitrate (2.2954 g) was added to the jar along with zirconia grinding medium, and the mixture was roll mixed for approximately 4 h. After separation of the powder from the grinding medium and transfer to a crucible, the mixture was heated in a furnace at 800° C. for 8 h for calcination to occur. A white powder (3.4968 g) was recovered from the furnace. The XRD patterns showed that the sample contained Li₄Ti₅O₂₂ as well as 6.9% Li₂TiO₃ and rutile (1.4%). BET surface analysis yielded a surface area of 2.0 m²/g.

### Example 3

### Preparation of Hydrated Titanium Dioxide

TiOCl₂ (5.7 mL of a 1.98 M solution prepared as described in Example 1) and water (246.2 mL) were added to a 1.0 L Morton Flask. The flask was mounted in a sand bath in a 2 L heating mantle. The temperature of the solution was controlled with a thermocouple inserted into the liquid. Stirring was done with an overhead stirrer with a single paddle impeller set at 1,100 rpm. The solution was held at 65° C. for approximately 90 min to allow time for the creation of seed crystals. After 90 min, TiOCl₂ solution (1.98 M solution prepared as described in Example 1) was added at a rate of 4.1 mL/L/min using an addition funnel to bring the titanium concentration to 1.0 M in the flask; at the start of this addition, the flask temperature was raised to 75° C. The addition took approximately 2 h to complete, and then the resulting mixture was stirred at temperature for an additional 30 min. The reaction mixture was then filtered, and the collected solids were washed with water and air-dried overnight.

Hydrated titanium oxide (37.5166 g) was recovered after drying. The titanium content of this solid was 52.10% as determined by ICP-AES. BET surface area analysis gave a surface area of 99 m²/g. The XRD pattern showed a rutile phase, and the SEM images showed particles as an agglomeration of smaller particles.

### Example 4

### Preparation of Li₄Ti₅O₁₂ from Hydrated Titanium Dioxide

The hydrated titanium dioxide described in Example 3 (4.1663 g) was placed in a 2 ounce (29.6 mL) PTFE-lined square glass jar and dried for 4 h in a vacuum oven at 75° C. Lithium nitrate (2.4998 g) was added to the jar along with zirconia grinding medium, and the mixture was roll mixed for approximately 4 h. After separation of the powder from the grinding medium and transfer to a crucible, the mixture was heated in a furnace at 800° C. for 8 h for calcination to occur. A white powder (3.9815 g) was recovered from the furnace. The XRD patters showed that the sample contained Li₄Ti₅O₁₂ as well as Li₂TiO₃ (1.4%) and rutile (4.1%). BET surface analysis yielded a surface area of 2.3 m²/g.

### Example 5

### Preparation of Hydrated Titanium Dioxide

TiOCl₂ (3.3 mL of a 1.98 M solution prepared as described in Example 1) and water (241.4 mL) were added to a 1.0 L Morton Flask. The flask was mounted in a sand bath in a 2 L heating mantle. The temperature of the solution was controlled with a thermocouple inserted into the liquid. Stirring was done with an overhead stirrer with a single paddle impeller set at 1,100 rpm. The solution was held at 65° C. for approximately 90 min to allow time for the creation of seed crystals. After 90 min, TiOCl₂ solution (1.98 M solution prepared as described in Example 1) was added at a rate of 3.8 mL/L/min using an addition funnel to bring the titanium concentration to 1.0 M in the flask; at the start of this addition, the flask temperature was raised to 75° C. The addition took approximately 2.25 h to complete, and then the resulting mixture was stirred at temperature for an additional 30 min. The reaction mixture was then filtered, and the collected solids were washed with water and air-dried overnight.

Hydrated titanium oxide (41.6819 g) was recovered after drying. The titanium content of this solid was 51.82% as determined by ICP-AES. BET surface area analysis gave a surface area of 98.4 m²/g. The XRD pattern showed a rutile phase with 7.6% anatase, and the SEM images showed particles as an agglomeration of smaller particles of approximately 1 μm in diameter.

### Example 6

### Preparation of Li₄Ti₅O₁₂ from Hydrated Titanium Dioxide

The hydrated titanium dioxide described in Example 5 (4.6230 g) was placed in a 2 ounce (29.6 mL) PTFE-lined square glass jar. Lithium nitrate (2.6439 g) was added to the jar along with zirconia grinding medium, and the mixture was roll mixed for approximately 4 h. After separation of the powder from the grinding medium and transfer to a crucible, the mixture (6.7268 g) was heated in a furnace at 800° C. for 8 h for calcination to occur. A white powder (3.9815 g) was recovered from the furnace. The XRD patters showed that the sample contained Li₄Ti₅O₁₂ as well as Li₂TiO₃ (2.1%) and rutile (1.9%). BET surface analysis yielded a surface area of 2.6 m²/g.

### Example 7

### Preparation of Hydrated Titanium Dioxide

TiOCl₂ (3.4 mL of a 1.94 M solution prepared as described in Example 1) and water (238.9 mL) were added to a 1.0 L Morton Flask. The flask was mounted in a sand bath in a 2 L heating mantle. The temperature of the solution was controlled with a thermocouple inserted into the liquid. Stirring was done with an overhead stirrer with a single paddle impeller set at 1,100 rpm. The solution was held at 65° C. for approximately 90 min to allow time for the creation of seed crystals. After 90 min, TiOCl₂ solution (1.94 M solution prepared as described in Example 1) was added at a rate of 3.8 mL/L/min using an addition funnel to bring the titanium concentration to 1.0 M in the flask; at the start of this addition, the flask temperature was raised to 75° C. The addition took approximately 2.25 h to complete, and then the resulting mixture was stirred at temperature for an additional 30 min. The reaction flask was removed from the heating mantle and 100 mL of water added to the sample. The solution was stirred for 15 min at 530 rpm. The reaction mixture was then filtered, and the collected solids were washed with water and air-dried overnight.

Hydrated titanium oxide (43.3866 g) was recovered after drying. The titanium content of this solid was 51.59% as determined by ICP-AES. BET surface area analysis gave a surface area of 121 m²/g. The XRD pattern showed a rutile phase with 19.2% anatase.

### Example 8

### Preparation of Hydrated Titanium Dioxide

TiOCl₂ (3.3 mL of a 2.01 M solution prepared as described in Example 1) and water (251.1 mL) were added to a 1.0 L Morton Flask. The flask was mounted in a sand bath in a 2 L heating mantle. The temperature of the solution was controlled with a thermocouple inserted into the liquid. Stirring was done with an overhead stirrer with a single paddle impeller set at 1,100 rpm. The solution was held at 65° C. for approximately 90 min to allow time for the creation of seed crystals. After 90 min, TiOCl₂ solution (2.01 M solution prepared as described in Example 1) was added at a rate of 5.5 mL/L/min using an addition funnel to bring the titanium concentration to 0.7 M in the flask; at the start of this addition, the flask temperature was raised to 75° C. The addition took approximately 2 h to complete, and then the resulting mixture was stirred at temperature for an additional 30 min. The solution was then removed from the heating mantle, and filtered under vacuum overnight. A chunky white solid was taken from the filter and placed in a vacuum oven at 75° C. to remove any remaining water. After 2 h the solid was removed from the oven and crushed using an agate mortar and pestle.

Hydrated titanium oxide (19.8917 g) was recovered after drying. The titanium content of this solid was 51.70% as determined by ICP-AES. BET surface area analysis gave a surface area of 124 m²/g. The XRD pattern showed a rutile phase with 11.2% anatase.

### Example 9

### Preparation of Hydrated Titanium Dioxide

TiOCl₂ (3.0 mL of a 1.57 M solution prepared as described in Example 1) and water (170.3 mL) were added to a 0.5 L, 3-neck Morton Flask. The flask was mounted in a sand bath in a 2 L heating mantle. The temperature of the solution was controlled with a thermocouple inserted into the liquid. Stirring was done with an overhead stirrer with a single paddle impeller set at 1,100 rpm. The solution was held at 65° C. for approximately 90 min to allow time for the creation of seed crystals. After 90 min, TiOCl₂ solution (1.57 M solution prepared as described in Example 1) was added at a rate of 2.6 mL/L/min using a peristaltic pump to bring the titanium concentration to 0.5 M in the flask; at the start of this addition, the flask temperature was raised to 75° C. The addition took approximately 50 min to complete, and then the resulting mixture was stirred at temperature for an additional 30 min. The solution was then removed from the heating mantle, and filtered under vacuum overnight. A chunky white solid was taken from the filter and placed in a vacuum oven at 75° C. to remove any remaining water. After 2 h the solid was removed from the oven and crushed using an agate mortar and pestle.

Hydrated titanium oxide (11.572 g) was recovered after drying. The titanium content of this solid was 49.00% as determined by ICP-AES. BET surface area analysis gave a surface area of 146 m²/g. The XRD pattern showed a rutile phase with 22.4% anatase.

### Example 10

### Preparation of Li₄Ti₅O₁₂ from Hydrated Titanium Dioxide

The hydrated titanium dioxide described in Example 9 (4.2669 g) was placed in a Teflon-lined plastic jar. Lithium nitrate (2.5956 g) was added to the jar along with zirconia grinding medium, and the mixture was tumble mixed for approximately 5 h. After separation of the powder from the grinding medium and transfer to a crucible, the mixture was hand ground with an agate mortar and pestle and then heated in a furnace at 800° C. for 8 h for calcination to occur. A white powder (4.0240 g) was recovered from the furnace. The XRD patters showed that the sample contained Li₄Ti₅O₁₂ as well as some rutile. BET surface analysis yielded a surface area of 3.5 m²/g.

### Comparative Example 1

### Preparation of Li₄Ti₅O₁₂

Lithium titanate (Li₄Ti₅O₁₂) was prepared according to the method taught by Thompson (WO 2011/146838 A2). Specifically, hydrated titanium dioxide was prepared as described in Example 2 of WO 2011/146838 A2. Then, lithium titanate was prepared by dry mixing the hydrated titanium dioxide with lithium carbonate.

Titanium oxychloride (TiOCl₂) solution was prepared as described in Example 1. TiOCl₂ solution (251.8 mL of 1.8 M TiOCl₂) was added to a 1-L three-neck mL Morton flask containing 148.2 mL of water. This ratio was chosen to yield a 1.2 M solution. The flask was placed in the center of a 2-L heating mantel and the flask was buried in sand. An overhead stirrer with Teflon® paddle blade and a distillation head and condenser were added. A 250 mL round-bottom flask was used as a condensate receiver. The system was connected to a temperature controller and a condenser attached to a round bottom collector and a distillation tube connected to an off gas vent to a sodium bicarbonate scrubber. The solution was stirred using an overhead digital stirrer at 1,100 rpm. The solution was heated at 109° C. for approximately 3 h to allow for nucleation and particle growth. Approximately 50 mL of HCl azeotrope was distilled. The resulting solids were then collected via filtration, washed, and air-dried; 42.12 g of hydrated titanium dioxide was obtained. XRD analysis showed the formation of a rutile phase. ICP-AES analysis showed the solid to contain 52.10 wt % titanium. SEM analysis showed the particles to be spherical with diameters of 1-12 μm.

Lithium titanate was prepared in the following manner. Hydrated titanium oxide (4.0206 g) was dry-mixed in a 4 ounce (118 mL) square jar with lithium carbonate (1.3265 g) for 6 h. The resulting mixture (5.1708 g) was calcined at 800° C. for 8 h. Lithium titanate (3.9545 g) was recovered from the furnace. XRD analysis showed the powder contained Li₄Ti₅O₁₂ (86.0%), Li₂TiO₃ (8.7%) and rutile (5.3%). The BET surface area was 0.6 m²/g. SEM analysis showed spherical particles of similar size to the hydrated titanium dioxide.

### Example 11

### Coin Cell Testing of Lithium Titanates

Coin cells fabricated used standard technique (T. Marks, S. Trussler, A. J. Smith, D. Xiong, and J. R. Dahn, Journal of the Electrochemical Society, 2011, 158, A51-A57) using a 80:10:10 mixture of lithium titanate: carbon: PVDF (polyvinylidene difluorde). 1-Methyl-2-pyrrolidone was used as solvent to form a paste for deposition of the active material on a copper foil. Li metal was used as the counter electrode. The coin cells were assembled in a dry box (Vacuum Atmospheres Co., Topsfield, Mass.) under an argon atmosphere. Electrochemical data was obtained on using a Maccor potentiostat (Maccor, Inc., Tulsa, Okla.).

The results are presented in Table 1, which lists the measured capacities for coin cells with Li₄Ti₅O₁₂ samples prepared in Examples 2, 4, and 6, and Comparative Example 1 versus a lithium metal counter electrode at 0.1 and 1 C rates.

TABLE 1
Capacities of Coin Cells Containing Lithium Titanate Samples

| Lithium | BET surface | 0.1 C Capacity | 1 C Capacity |
|---|---|---|---|
| Titanate | area (m²/g) | (mAh/g) | (mAh/g) |
| Example 2 | 2.0 | 168 | 146 |
| Example 4 | 2.3 | 159 | 143 |
| Example 6 | 2.6 | 170 | 158 |
| Comparative | 0.6 | 116 | 35 |
| Example 1 | | | |

As can be seen from the results in Table 1, coin cells prepared using the Li₄Ti₅O₁₂ prepared by the process disclosed herein had a higher capacity than coin cells prepared with Li₄Ti₅O₁₂ prepared by the process known in the art, particularly at high C rates.

What is claimed is:

1. A process for preparing Li₄Ti₅O₁₂, comprising the steps of:
a) hydrolyzing TiCl₄ in an aqueous medium to provide a first aqueous solution containing TiOCl₂ at a concentration of about 0.5 M to about 2.0 M;
b) generating a seed suspension by adding a portion of the first aqueous solution containing TiOCl₂ to a second aqueous medium to provide a second aqueous solution containing TiOCl₂ at a concentration of about 0.01 M to about 0.1 M, and agitating and heating the second aqueous solution to a temperature of about 60° C. to about 80° C. for a period of time sufficient to provide the seed suspension containing hydrated titanium dioxide particles having a particle size less than 100 nm;
c) generating a suspension containing hydrated TiO₂ particles by adjusting the temperature of the seed suspension to about 70° C. to about 100° C., adding the first aqueous solution containing TiOCl₂ to the seed suspension at a rate of less than 15 mL/L/min while agitating the seed suspension to provide a reaction mixture having a concentration of TiOCl₂ of about 0.7 M to about 1.8 M, and continuing agitating and heating the reaction mixture at a temperature of about 70° C. to about 100° C. for a period of time sufficient to prepare the suspension containing hydrated TiO₂ particles, wherein the hydrated TiO₂ particles have a particle size of about 0.4 μm to about 5.0 μm;
d) recovering the hydrated TiO₂ particles from the suspension of step (c);
e) mixing the hydrated TiO₂ particles with a lithium salt to prepare a mixture having a Li to Ti ratio of about 0.6 to about 1.0; and
f) calcining the mixture from step (e) at a temperature of about 750° C. to about 1,000° C. for a period of time sufficient to prepare Li₄Ti₅O₁₂.

2. The process of claim 1, wherein the aqueous medium in step (a) is maintained at a temperature of about −20° C. to about 20° C.

3. The process of claim 1, wherein the aqueous medium in step (a) is maintained at a temperature of about −5° C. to about 5° C.

4. The process of claim 1, wherein the concentration of TiOCl₂ in the aqueous solution in step (a) is about 1.0 M to about 2.0 M.

5. The process of claim 1, wherein the second aqueous solution of step (b) has a TiOCl₂ concentration of about 0.02 M to about 0.05 M.

6. The process of claim 1, wherein the second aqueous solution of step (b) is heated to a temperature of about 65° C. to about 75° C.

7. The process of claim 1, wherein the seed suspension of step (c) is heated to a temperature of about 75° C. to about 90° C.

8. The process of claim 1, wherein the first aqueous solution containing TiOCl₂ is added to the seed suspension at a rate of about 1.0 mL/L/min to about 10 mL/L/min.

9. The process of claim 1, wherein the agitating of step (c) is at a rate to give turbulent flow.

10. The process of claim 1, wherein the mixture of Step (e) has a Li to Ti ratio of about 0.7 to about 0.9.

11. The process of claim 1, wherein the lithium salt is selected from the group consisting of lithium hydroxide, lithium carbonate, lithium sulfate, lithium phosphate, lithium nitrate, lithium carboxylates, and mixtures thereof.

12. The process of claim 11, wherein the lithium salt is lithium carbonate.

13. The process of claim 1, wherein the calcining of step (f) is at a temperature of about 750° C. to about 900° C.

14. The process of claim 1, wherein the Li₄Ti₅O₁₂ has a purity greater than 92% and a surface area greater than or equal to 2.0 m²/g.

15. A process for preparing titanium dioxide, comprising the steps of:
a) hydrolyzing TiCl₄ in an aqueous medium to provide a first aqueous solution containing TiOCl₂ at a concentration of about 0.5 M to about 2.0 M;
b) generating a seed suspension by adding a portion of the first aqueous solution containing TiOCl₂ to a second aqueous medium to provide a second aqueous solution containing TiOCl₂ at a concentration of about 0.01 M to about 0.1 M, and agitating and heating the second aqueous solution to a temperature of about 60° C. to about 80° C. for a period of time sufficient to provide the seed suspension containing hydrated titanium dioxide particles having a particle size less than 100 nm;
c) generating a suspension containing hydrated TiO₂ particles by adjusting the temperature of the seed suspension to about 70° C. to about 100° C., adding the first aqueous solution containing TiOCl₂ to the seed suspension at a rate of less than 15 mL/L/min while agitating the seed suspension to provide a reaction mixture having a concentration of TiOCl₂ of about 0.7 M to about 1.8 M, and continuing agitating and heating the reaction mixture at a temperature of about 70° C. to about 100° C. for a period of time sufficient to prepare the suspension containing hydrated TiO₂ particles, wherein the hydrated TiO₂ particles have a particle size of about 0.4 μm to about 5.0 μm;
d) recovering the hydrated TiO₂ particles from the suspension of step (c).
